(19) United States
(12) Patent Application Publication
(10) Pub. No.: US 2025/0320876 A1
(43) Pub. Date: Oct. 16, 2025

(54) MOUNTING STRUCTURE AND AIR PUMP

(71) Applicant: Shanghai Flextail Technology Co., Ltd, Shanghai (CN)

(72) Inventors: Xiaonan Li, Shanghai (CN); Guoliang Hu, Shanghai (CN); Chonghua Fei, Shanghai (CN); Cong Chen, Shanghai (CN)

(73) Assignee: Shanghai Flextail Technology Co., Ltd, Shanghai (CN)

(21) Appl. No.: 18/817,989

(22) Filed: Aug. 28, 2024

(30) Foreign Application Priority Data
Apr. 10, 2024 (CN) 202420732984.1

(51) Int. Cl. F04D 25/06; H01M 50/204; H01M 50/247

(52) U.S. Cl. CPC F04D 25/0673; H01M 50/204; H01M 50/247; H01M 2220/30

(57) ABSTRACT

The present application provides a mounting structure and an air pump. The mounting structure comprises a battery holder and a device body. Several batteries are spaced circumferentially on the battery holder, and a first through-hole is provided axially in middle of the battery holder. A motor is provided axially in the device body, with one end extending through and out of the device body and the other end extending through the first through-hole, and at least partially surrounded by the several batteries. The air pump includes the mounting structure. The mounting structure and the air pump of the present application arrange the batteries circumferentially on the battery holder, improving the overall stability of the air pump. The motor is relatively surrounded by the batteries in a compact manner, fully utilizing the internal space and improving the convenience of carrying the air pump.

### FIELD OF THE DISCLOSURE The present application relates to a field of inflation equipment, and further relates to a mounting structure and an air pump.

### BACKGROUND

In existing products, internal batteries and motors are mostly arranged in an axial stack, with the batteries placed below the motor to avoid mutual interference. However, this axial stacking of the batteries and the motor results in a relatively large overall product length, leading to poor overall balance and a tendency to topple during use. Additionally, the excessive length makes the product inconvenient to carry, resulting in a mediocre user experience.

### SUMMARY OF THE INVENTION

To address the above technical issues, the present application aims to provide a mounting structure and an air pump, where batteries are spaced circumferentially on a battery holder to improve the overall stability of the air pump. The motor is relatively surrounded by several batteries, making the installation of the motor and batteries more compact, fully utilizing the internal space of the air pump and improving the convenience of carrying the air pump.

To achieve the above purpose, the present application provides a mounting structure for installing a motor and batteries, comprising a battery holder and a device body, wherein several batteries are spaced circumferentially on the battery holder, and a first through-hole is provided in middle of the battery holder in an axial direction; and a motor is provided in middle of the device body in the axial direction, with one end of the motor extending through and out of the device body, and another end of the motor is adapted to extend through the first through-hole, and is at least partially surrounded by the several batteries.

In some embodiments, a bottom of the battery holder is provided with several first fixing brackets spaced circumferentially on the battery holder, and installation slots are configured between the several first fixing brackets, each installation slot being adapted to accommodate a battery; and one or more second fixing brackets are further provided outside of the first fixing brackets at the bottom of the battery holder, wherein the one or more second fixing brackets are adapted to abut against outer sidewalls of the batteries.

In some embodiments, both sides of the first fixing brackets in a circumferential direction are provided with first abutting slots, with a corner of the batteries adapted to abut against the first abutting slots; and a first mounting block each is provided on a side of the first fixing brackets away from an axis of the battery holder, with both sides of the first mounting block in the circumferential direction extending outward to form first abutting parts, the first abutting parts being adapted to abut against sidewalls of the batteries.

In some embodiments, the second fixing brackets are located radially outside the first fixing brackets, with both sides of the second fixing brackets extending circumferentially to form second abutting parts, the second abutting parts being located circumferentially outside the first abutting parts, and the second abutting parts being adapted to abut against the sidewalls of the batteries.

In some embodiments, a top of the battery holder is provided with several first fixing columns spaced circumferentially on the battery holder, and the first fixing columns are relatively positioned between adjacent first fixing brackets, and a side of the device body near the battery holder is provided with second fixing columns and a third fixing column, the second fixing columns being fixedly connected to the first fixing columns, and an end of the device body away from the battery holder is provided with a fan, and the third fixing column is provided with a third through-hole, and the motor is mounted in the third through-hole and connected to the fan.

In some embodiments, the top of the battery holder is further provided with a circuit board, the circuit board being relatively positioned inside the device body, and each first fixing column includes a fixing part and a placement part, with a diameter of the placement part being greater than a diameter of the fixing part, and the fixing part extends through the circuit board and connects to the second fixing columns, such that the circuit board is pressed between the second fixing columns and the placement parts, and the third fixing columns extend through middle of the circuit board.

In some embodiments, at the bottom of the battery holder is provided with a light board holder, and the light board holder is provided with several third fixing brackets spaced along the circumferential direction of the battery holder, and the third fixing brackets are fixedly mounted to the first fixing brackets of the battery holder, such that the batteries are fixedly installed between the battery holder and the light board holder.

In some embodiments, clamping holes are provided between the first fixing brackets and the second fixing brackets on the battery holder, and tops of the third fixing brackets are each provided with a clamping hook, the clamping hooks being adapted to snap into the clamping holes.

In some embodiments, the first mounting blocks of the first fixing brackets are each provided with a first mounting hole, and the third fixing brackets are each provided with a second mounting hole at positions corresponding to the first mounting holes, and mounting components are provided through the first mounting holes and the second mounting holes to assemble the battery holder and the light board holder together.

According to another aspect of the present application, an air pump is further provided, comprising any one of the above-mentioned preferred embodiments of mounting structures.

Compared with the prior art, the mounting structure and air pump provided by the present application have at least one of the following beneficial effects:
1. The batteries are spaced circumferentially on a battery holder, improving the overall stability of the air pump. The motor is relatively surrounded by the several batteries, making the installation of the motor and batteries more compact, fully utilizing the internal space of the air pump and improving the convenience of carrying the air pump.
2. Both ends of first fixing brackets in a circumferential direction are provided with first abutting slots, which match the curvature of sidewalls of the batteries. First abutting parts on both sides of first mounting blocks in the circumferential direction enhance the fixation of the battery sidewalls, preventing the batteries from shaking and moving.
3. Part of the battery holder is relatively positioned inside a device body. After the motor extends through a third through-hole of a third fixing column, it is connected to the fan. The third fixing column and the motor are both partially surrounded by the batteries, preventing damage to the batteries and motor, and improving the utilization of the internal space of the device body.
4. Third fixing brackets of a light board holder are fixedly mounted to the first fixing brackets of the battery holder. The batteries are fixedly installed between the battery holder and the light board holder, enhancing the stability of battery installation. The third and first fixing brackets are spaced apart, reducing the weight of the light board holder and the battery holder. This makes the mounting structure lighter and provides installation positions for the batteries, making the structure more compact.

### BRIEF DESCRIPTION OF THE DRAWINGS

Below, preferred embodiments of the present application will be further explained with the assistance of drawings in a clear and understandable manner, highlighting the above features, technical characteristics, advantages, and their implementation methods.

FIG. 1 is a cross-sectional view of a mounting structure.

FIG. 2 is an exploded view of the mounting structure.

FIG. 3 is an exploded view of a battery holder and a light board holder.

FIG. 4 is a structural view of the battery holder.

FIG. 5 is another structural view of the battery holder.

FIG. 6 is a structural view of the light board holder.

FIG. 7 is a structural view of a device body.

FIG. 8 is an installation view of the circuit board.

### EXPLANATION OF THE REFERENCE NUMBERS

Device body 1, Motor 11, Second fixing column 12, Third fixing column 13, Third through-hole 130, Fan 14, Circuit board 15, Battery holder 2, First through-hole 20, First fixing bracket 21, First abutting slot 211, First mounting block 212, First mounting hole 2120, First abutting part 2121, Second fixing bracket 22, Second abutting part 221, First fixing column 23, Fixing part 231, Placement part 232, Battery 24, Clamping hole 25, Axis 26, Light board holder 3, Third fixing bracket 31, Second mounting hole 310, Clamping hook 311.

### DESCRIPTION OF THE ILLUSTRATED EMBODIMENTS

To more clearly illustrate the embodiments of the present application or the technical solutions in the prior art, the following sections will describe specific embodiments of the present application with reference to the drawings. It is apparent that the drawings described below are merely some embodiments of the application. For those skilled in the art, based on these drawings, additional drawings and other embodiments can be obtained without creative work.

To simplify the drawings, only parts related to the application are schematically shown in each drawing. They do not represent the actual structure of a product. Additionally, to make the drawings concise and easy to understand, components with a same structure or function are schematically shown only once or marked only once. In this document, “one” does not mean “only one”, but can also mean “more than one”.

It should be further understood that, in this application, unless otherwise specified and limited, terms such as “mounted”, “connected”, and “fixed” should be interpreted broadly. For example, they can be fixedly connected, detachably connected, or integrally connected; mechanically connected or electrically connected; directly connected or indirectly connected through an intermediary; or they can be internal connections of two components. For those skilled in the art, the specific meanings of these terms in the application can be understood according to specific situations.

Furthermore, in this application's description, terms such as “first” and “second” are only used to distinguish different descriptions and are not intended to indicate or imply relative importance. It should be noted that the above embodiments can be freely combined as needed. The above descriptions are merely preferred embodiments of the application. For those skilled in the art, various modifications and changes can be made without departing from the principle of the application, and these modifications and changes should also be considered as within the scope of the application.

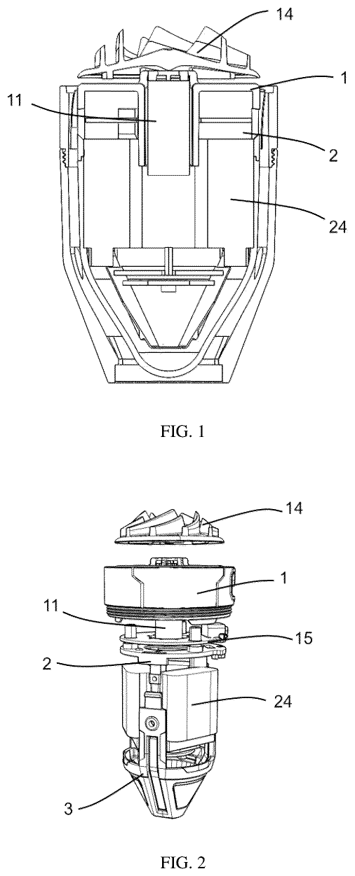

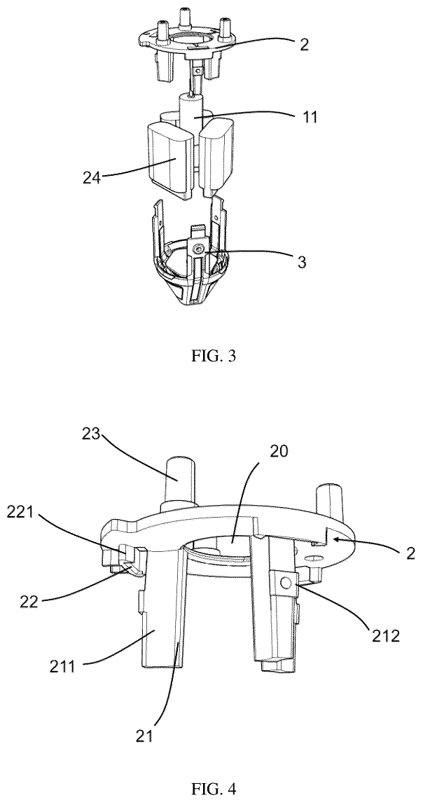

Referring to FIG. 1 to FIG. 4, the present application provides a mounting structure for installing a motor 11 and batteries 24. The mounting structure includes a battery holder 2 and a device body 1. The battery holder 2 is provided with several batteries 24 spaced circumferentially, and a first through-hole 20 is provided in the middle of the battery holder 2 in an axial direction. The device body 1 is provided with a motor 11 in the middle in the axial direction, with one end of the motor 11 extending through and out of the device body 1. The other end of the motor 11 is adapted to extend through the first through-hole 20, and this end of the motor 11 is at least partially surrounded by the several batteries 24.

In this embodiment, the batteries 24 are spaced circumferentially on the battery holder 2, improving the overall stability of the air pump. The motor 11 is relatively surrounded by the several batteries 24, making the installation of the motor 11 and batteries 24 more compact, fully utilizing the internal space of the air pump, and improving the convenience of carrying the air pump.

Specifically, the bottom of the battery holder 2 is provided with several first fixing brackets 21 spaced circumferentially. Installation slots are provided between the first fixing brackets 21, each installation slot being adapted to accommodate a battery 24. The first fixing brackets 21 are spaced apart to provide installation spaces for the batteries 24, and the first fixing brackets 21 are hollow to make the battery holder 2 more lightweight and compact. More specifically, the bottom of the battery holder 2 is provided with three first fixing brackets 21. One battery 24 is placed between each pair of adjacent first fixing brackets 21, forming a triangular arrangement of three batteries 24. The motor 11 is positioned relatively in the center of the triangle formed by the three batteries 24. Additionally, the bottom of the battery holder 2, on the outer side of the first fixing brackets 21, is provided with second fixing brackets 22, which are adapted to abut against outer sidewalls of the batteries 24, enhancing the fixation and preventing the batteries 24 from shaking or moving.

It is worth noting that the number of batteries 24 and first fixing brackets 21 is not limited in this application. The number three used in this embodiment are only for demonstration purposes; and the number could also be two or more than three. All such variations are within the scope of this application. The batteries 24 in this application are standard batteries 24, and the shapes of the batteries 24 are not further described as long as the motor 11 is surrounded by the several batteries 24, which is within the scope of this application.

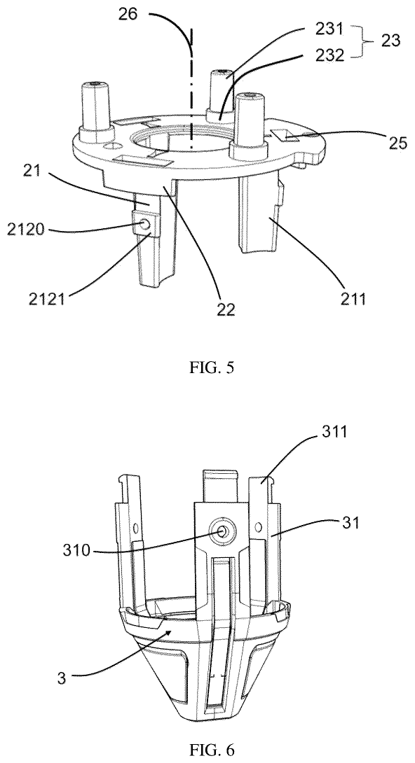

Further referring to FIG. 4 and FIG. 5, the sides of the first fixing brackets 21 in the circumferential direction are provided with first abutting slots 211, which are adapted to abut against a corner of the batteries 24. A side of the first fixing brackets 21 away from the axis 26 of the battery holder 2 is provided with first mounting blocks 212. The sides of the first mounting blocks 212 in the circumferential direction extend outward to form first abutting parts 2121, which are adapted to abut against the sidewalls of the batteries 24.

In this embodiment, the circumferential sides of the first fixing brackets 21 are provided with first abutting slots 211, which match the curvature of the side wall of the batteries 24. The first abutting parts 2121 on both sides of the first mounting blocks 212 in the circumferential direction serve to reinforce the fixation of the side wall of the battery 24, preventing the batteries 24 from shaking and moving.

Specifically, the second fixing brackets 22 are located radially outward of the first fixing brackets 21. The circumferential sides of the second fixing bracket 22 extend circumferentially to form second abutting parts 221. These second abutting parts 221 are positioned circumferentially outward of the first abutting parts 2121 and are suitable for abutting against the side wall of the batteries 24.

It is noteworthy that, in this embodiment, the second fixing brackets 22 are positioned radially outward of the first fixing brackets 21, i.e., one first fixing bracket 21 and one second fixing bracket 22 are on a same radius of the battery holder 2. In a modified embodiment, one second fixing bracket 22 can also be positioned between adjacent first fixing brackets 21, i.e., the second fixing brackets 22 and the first fixing brackets 21 are alternately arranged. In this case, the second fixing brackets 22 abut against the side wall of the batteries 24 in between.

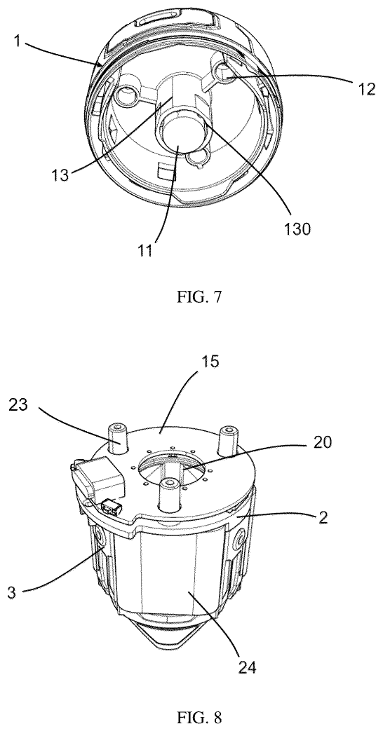

Furthermore, referring to FIGS. 4 and 7, the top of the battery holder 2 is intermittently provided with several first fixing columns 23 along its circumferential direction. The first fixing columns 23 are positioned between adjacent first fixing brackets 21. One side of the device body 1, near the battery holder 2, is also provided with second fixing columns 12 and a third fixing column 13. The second fixing columns 12 are fixedly connected to the first fixing columns 23. A fan 14 is located at the end of the device body 1, away from the battery holder 2. The third fixing column 13 has a third through-hole 130, where the motor 11 is installed and connected to the fan 14.

In this embodiment, part of the battery holder 2 is positioned inside the device body 1. The motor 11, after passing through the third through-hole 130 of the third fixing column 13, is connected to the fan 14. Both the third fixing column 13 and the motor 11 are located surrounded by the batteries 24, preventing damage to the batteries 24 and the motor 11 while improving the utilization of the internal space of the device body 1.

Specifically, the second fixing columns 12 are spaced along the circumferential direction of the battery holder 2. The third fixing column 13 is positioned on the central axis of the device body 1 and extends to the inside of the battery holder 2 in a direction away from the device body 1. The third fixing column 13 is relatively positioned in the middle of the batteries 24, and its bottom side wall is also provided with a third abutting part that abuts against the other side wall of the batteries 24. Referring to FIG. 7 and FIG. 8, the top of the battery holder 2 is also provided with a circuit board 15, which is relatively positioned inside the device body 1. The first fixing columns 23 and the motor 11 both pass through the circuit board 15. The first fixing columns 23 each includes a fixing part 231 and a placement part 232, with the fixing part 231 located above the placement part 232. The diameter of the fixing part 231 is smaller than that of the placement part 232. After the fixing part 231 passes through the circuit board 15, the circuit board 15 is placed on the placement parts 232. The fixing part 231 is fixedly installed with the second fixing columns 12, which abuts against the other side of the circuit board 15 away from the placement parts 232. This arrangement presses the circuit board 15 between the second fixing columns 12 and the placement parts 232, improving the stability of the circuit board 15 and preventing its displacement and damage. The third fixing column 13 passes through the middle of the circuit board 15, and the motor 11 is installed inside the third through-hole 130 of the third fixing column 13.

Further, referring to FIG. 5 and FIG. 6, at the bottom of the battery holder 2 is also provided with a light board holder 3. The light board holder 3 is intermittently provided with several third fixing brackets 31 along the circumferential direction of the battery holder 2. The third fixing brackets 31 are fixedly installed with the first fixing brackets 21 of the battery holder 2, securing the batteries 24 between the battery holder 2 and the light board holder 3.

In this embodiment, the third fixing brackets 31 of the light board holder 3 are fixedly installed with the first fixing brackets 21 of the battery holder 2. The batteries 24 are secured between the battery holder 2 and the light board holder 3, improving the stability of the installation of batteries 24. Both the third fixing brackets 31 and the first fixing brackets 21 are spaced apart, reducing the weight of the light board holder 3 and the battery holder 2. This makes the mounting structure more lightweight and leaves installation positions for the batteries 24, making the structure more compact.

Specifically, clamping holes 25 are provided between the first fixing brackets 21 and the second fixing brackets 22 of the battery holder 2. The top of the third fixing brackets 31 of the light board holder 3 are each provided with a clamping hook 311, which is suitable for being clamped into one of the clamping holes 25. The first mounting blocks 212 of the first fixing brackets 21 are also each provided with a first mounting hole 2120. The third fixing brackets 31 are each provided with a second mounting hole 310 at a corresponding position of one of the first mounting holes 2120. Mounting components are suitable for being assembled through the first mounting hole 2120 and the second mounting hole 310, assembling the battery holder 2 and the light board holder 3 together.

Further, the device body 1 is also provided with a deflector shell, with the fan 14 at the device body 1 positioned inside the deflector shell.

Additionally, referring to FIG. 1, the present application provides an air pump, which includes any of the above embodiments of the mounting structure.

It should be noted that the above embodiments can be freely combined as needed. The above are merely preferred embodiments of the application. For those skilled in the art, various improvements and modifications can be made without departing from the principles of the application, and these improvements and modifications should also be considered within the scope of the application.

1. A mounting structure for installing a motor and batteries, characterized by comprising:
a battery holder, wherein several batteries are spaced circumferentially on the battery holder, and a first through-hole is provided in middle of the battery holder in an axial direction;
a device body, wherein a motor is provided in middle of the device body in the axial direction, with one end of the motor extending through and out of the device body, and another end of the motor is adapted to extend through the first through-hole, and is at least partially surrounded by the several batteries.

2. The mounting structure according to claim 1, characterized in that a bottom of the battery holder is provided with several first fixing brackets spaced circumferentially on the battery holder, and installation slots are configured between the several first fixing brackets, each installation slot being adapted to accommodate a battery; and one or more second fixing brackets are further provided outside of the first fixing brackets at the bottom of the battery holder, wherein the one or more second fixing brackets are adapted to abut against outer sidewalls of the batteries.

3. The mounting structure according to claim 2, characterized in that both sides of the first fixing brackets in a circumferential direction are provided with first abutting slots, with a corner of the batteries adapted to abut against the first abutting slots; and
a first mounting block each is provided on a side of the first fixing brackets away from an axis of the battery holder, with both sides of the first mounting block in the circumferential direction extending outward to form first abutting parts, the first abutting parts being adapted to abut against sidewalls of the batteries.

4. The mounting structure according to claim 3, characterized in that the second fixing brackets are located radially outside the first fixing brackets, with both sides of the second fixing brackets extending circumferentially to form second abutting parts, the second abutting parts being located circumferentially outside the first abutting parts, and the second abutting parts being adapted to abut against the sidewalls of the batteries.

5. The mounting structure according to claim 2, characterized in that
a top of the battery holder is provided with several first fixing columns spaced circumferentially on the battery holder, and the first fixing columns are relatively positioned between adjacent first fixing brackets, and a side of the device body near the battery holder is provided with second fixing columns and a third fixing column, the second fixing columns being fixedly connected to the first fixing columns, and an end of the device body away from the battery holder is provided with a fan, and the third fixing column is provided with a third through-hole, and the motor is mounted in the third through-hole and connected to the fan.

6. The mounting structure according to claim 5, characterized in that the top of the battery holder is further provided with a circuit board, the circuit board being relatively positioned inside the device body, and each first fixing column includes a fixing part and a placement part, with a diameter of the placement part being greater than a diameter of the fixing part, and the fixing part extends through the circuit board and connects to the second fixing columns, such that the circuit board is pressed between the second fixing columns and the placement parts, and the third fixing column extends through middle of the circuit board.

7. The mounting structure according to claim 2, characterized in that
at the bottom of the battery holder is provided with a light board holder, and the light board holder is provided with several third fixing brackets spaced along the circumferential direction of the battery holder, and the third fixing brackets are fixedly mounted to the first fixing brackets of the battery holder, such that the batteries are fixedly installed between the battery holder and the light board holder.

8. The mounting structure according to claim 7, characterized in that clamping holes are provided between the first fixing brackets and the second fixing brackets on the battery holder, and tops of the third fixing brackets are each provided with a clamping hook, the clamping hooks being adapted to snap into the clamping holes.

9. The mounting structure according to claim 7, characterized in that
first mounting blocks of the first fixing brackets are each provided with a first mounting hole, and the third fixing brackets are each provided with a second mounting hole at positions corresponding to the first mounting holes, and mounting components are provided through the first mounting holes and the second mounting holes to assemble the battery holder and the light board holder together.

10. An air pump, characterized by comprising
a mounting structure, wherein the mounting structure comprising:
a battery holder, wherein several batteries are spaced circumferentially on the battery holder, and a first through-hole is provided in middle of the battery holder in an axial direction;
a device body, wherein a motor is provided in middle of the device body in the axial direction, with one end of the motor extending through and out of the device body, and another end of the motor is adapted to extend through the first through-hole, and is at least partially surrounded by the several batteries.

11. The air pump according to claim 10, characterized in that
a bottom of the battery holder is provided with several first fixing brackets spaced circumferentially on the battery holder, and installation slots are configured between the several first fixing brackets, each installation slot being adapted to accommodate a battery; and one or more second fixing brackets are further provided outside of the first fixing brackets at the bottom of the battery holder, wherein the one or more second fixing brackets are adapted to abut against outer sidewalls of the batteries.

12. The air pump according to claim 11, characterized in that
both sides of the first fixing brackets in a circumferential direction are provided with first abutting slots, with a corner of the batteries adapted to abut against the first abutting slots; and
a first mounting block each is provided on a side of the first fixing brackets away from an axis of the battery holder, with both sides of the first mounting block in the circumferential direction extending outward to form first abutting parts, the first abutting parts being adapted to abut against sidewalls of the batteries.

13. The air pump according to claim 12, characterized in that the second fixing brackets are located radially outside the first fixing brackets, with both sides of the second fixing brackets extending circumferentially to form second abutting parts, the second abutting parts being located circumferentially outside the first abutting parts, and the second abutting parts being adapted to abut against the sidewalls of the batteries.

14. The air pump according to claim 11, characterized in that
a top of the battery holder is provided with several first fixing columns spaced circumferentially on the battery holder, and the first fixing columns are relatively positioned between adjacent first fixing brackets, and a side of the device body near the battery holder is provided with second fixing columns and a third fixing column, the second fixing columns being fixedly connected to the first fixing columns, and an end of the device body away from the battery holder is provided with a fan, and the third fixing column is provided with a third through-hole, and the motor is mounted in the third through-hole and connected to the fan.

15. The air pump according to claim 14, characterized in that
the top of the battery holder is further provided with a circuit board, the circuit board being relatively positioned inside the device body, and
each first fixing column includes a fixing part and a placement part, with a diameter of the placement part being greater than a diameter of the fixing part, and the fixing part extends through the circuit board and connects to the second fixing columns, such that the circuit board is pressed between the second fixing columns and the placement parts, and
the third fixing column extends through middle of the circuit board.

16. The air pump according to claim 11, characterized in that
at the bottom of the battery holder is provided with a light board holder, and
the light board holder is provided with several third fixing brackets spaced along the circumferential direction of the battery holder, and
the third fixing brackets are fixedly mounted to the first fixing brackets of the battery holder, such that the batteries are fixedly installed between the battery holder and the light board holder.

17. The air pump according to claim 16, characterized in that
clamping holes are provided between the first fixing brackets and the second fixing brackets on the battery holder, and
tops of the third fixing brackets are each provided with a clamping hook, the clamping hooks being adapted to snap into the clamping holes.

18. The air pump according to claim 16, characterized in that
the first mounting blocks of the first fixing brackets are each provided with a first mounting hole, and
the third fixing brackets are each provided with a second mounting hole at positions corresponding to the first mounting holes, and
mounting components are provided through the first mounting holes and the second mounting holes to assemble the battery holder and the light board holder together.

19. The air pump according to claim 11, characterized in that
the battery holder is provided with three first fixing brackets, and
one battery each is placed between each pair of adjacent first fixing brackets, forming a triangular arrangement of three batteries, and the motor is positioned relatively in center of a triangle formed by the three batteries.

20. The air pump according to claim 11, characterized in that
the second fixing brackets and the first fixing brackets are alternately arranged, such that the second fixing brackets abut against side walls of the batteries between the first fixing brackets.
